(19) United States
(12) Patent Application Publication
(10) Pub. No.: US 2015/0245030 A1
(43) Pub. Date: Aug. 27, 2015

(54) VIDEO CODING AND DECODING

(71) Applicant: BRITISH BROADCASTING CORPORATION, London (GB)

(72) Inventors: Marta Mrak, London (GB); Matteo Naccari, London (GB); David Flynn, Croydon Surrey (GB); Andrea Gabriellini, Guildford (GB)

(21) Appl. No.: 14/408,522

(22) PCT Filed: Jun. 19, 2013
(86) PCT No.: PCT/GB2013/051598

§ 371 Date: Dec. 16, 2014

(30) Foreign Application Priority Data
Jun. 19, 2012 (GB) 1210853.6

(51) Int. Cl. H04N 19/136; H04N 19/184; H04N 19/12

(52) U.S. Cl. CPC H04N 19/136; H04N 19/12; H04N 19/184

(57) ABSTRACT

In video encoding, where image values are transformed to provide transform coefficients and transform coefficients are quantised to derive a compressed bitstream, an ID profile is selected at the encoder and used with a representative image intensity to scale image values in the block. The selected ID profile is signalled to the decoder with the compressed bitstream. At the decoder, the ID profile is extracted from the compressed bitstream and—after performing inverse quantisation and an inverse transform to form image values—those image values are inverse scaled.

### FIELD OF THE INVENTION

This invention is related to video compression and decompression systems.

### BACKGROUND TO THE INVENTION

This invention is directed to the video coding area which aims at compressing video content as much as is possible without significantly compromising its visual quality. Typically, the compression is attained by exploiting statistical data redundancies in the spatial and temporal dimensions. Given the high amount of data related to video, state-of-the-art video coding standard (e.g. MPEG-2, MPEG-4, H.264/AVC, etc.) use compression in a lossy fashion, whereas lossy in this context means that the decompressed signal is different to the original one before compression. During such compression, parts of video data are discarded/reduced by applying quantisation whereby the video data are scaled at the encoder to reduce their value and expanded at the decoder to reconstruct it. In this context, video data may refer to the image pixels as well as any data obtained by applying some related processing over the pixels (e.g. frequency transformation, temporal or spatial prediction, etc). The quantisation can be made more adaptive by exploiting some characteristics of the image as spatial activity, level of motion activity, luminance intensity, etc. These characteristics can be combined and used as input to a rule or a set of rules which decide the amount of scaling (by the quantisation) to be used over an image area to be coded. Moreover, the quantisation can be made adaptive also with respect to the rule used in the quantisation step selection. In particular, a different rule can be used depending on the image features or on the different effect one may want to introduce in the image area. Additionally, considering coding of high dynamic range images, it may be beneficial to apply different coding strategies on different areas whereas the pixel range varies. It will be understand by the embodiments of this invention that the quantisation step is now dependent on the image-related features computation which may involve a significant amount of computational resources. For some decoder architectures the inverse quantisation is conducted at a time or in a process pipe where the feature computation may not have been formed. Therefore, the aforementioned quantisation step dependency on image features may be a critical factor in determining processor resource.

### SUMMARY OF THE INVENTION

It is an object of this invention to provide methods of encoding and decoding which allow additional coding efficiencies dictated by encoder to be obtained, without introducing additional dependencies at the de-quantisation levels.

Accordingly, the present invention consists in one aspect in a method of video encoding in which an image is divided into blocks; image intensity values in at least some blocks are transformed to provide transform coefficients and said transform coefficients are quantised with quantisation parameters that vary between said coefficients to derive a compressed bitstream; comprising the steps of:
at the encoder, selecting a compression control rule; for an image area, identifying for that area a compression control parameter, the said compression control parameter varying between at least some areas; varying values in the block in accordance with said compression control profile operating on said compression control parameter; signalling the selected compression control profile in association with the compressed bitstream: and
at the decoder, extracting the compression control profile from the compressed bitstream; performing inverse quantisation; performing where appropriate an inverse transform to form values; and varying said values in accordance with the signalled compression control profile operating on the identified compression control parameter.

In some embodiments this invention provides video compression and decompression systems with a framework to adaptively vary pixel values during image reconstruction. In this framework a selection of compression parameters is used to derive the varying effect used over each image area. The process affects spatial domain elements, just before reconstruction, and is therefore different from the standard quantisation used in frequency domain. However it can be used in the same framework where transforms are applied.

Preferably, the steps of varying values comprise expanding or compressing the dynamic range; for example compressing the dynamic range of pixel values at the encoder and expanding the dynamic range of values at the decoder.

Suitably, the values that are varied can be residual values formed at the encoder after subtraction of a prediction and formed at the decoder prior to addition of the prediction. Additionally, for some images it may be desirable to control the application of such rules by limiting it to some segment/block. In that case the usage of rules can be controlled by segment—related coding flags.

It may sometimes be convenient to define the expanding or compressing of the dynamic range as scaling by a scaling parameter.

Thus, a scaling operation can be described by the following operation:

$${r}^{′} = ⌊ \frac{r}{Δ} ⌋$$

where r denotes the prediction residue, r′ denotes the scaled residue and Δ is a scaling parameter. In the inverse scaling process, the residue reconstructed at the decoder after inverse transformation is re-scaled by applying the following operation:

\hat{r}=\hat{r}′×Δ

where \hat{r} denotes the final reconstructed residue and \hat{r}′denotes the reconstructed residue after inverse transformation.

Another important aspect of the invention is related to the realisation that compression control rules depend on the given content, i.e. on a given image. Therefore this invention enables rule selection for each spatio-temporal video segment. A spatio-temporal video segment may be an image region, such as a slice or a tile; a plurality of images, such as a Group Of Pictures (GOP), a video shot or a video programme.

The present invention can be used when high dynamic range images are considered, because of different precision needed for coding of different parts of such images (e.g. overlays are usually with lower range and some intensity values require lower precision).

The present invention can also be used to take advantage of some masking phenomena related to the Human Visual System (HVS). One example of these phenomena is the one related to the average pixel intensity.

For this masking, the compression rule may be the Intensity Dependent (ID) profile which models the HVS masking to the image area average pixel intensity. That is because ID coding can be seen as a general case of Just Noticeable Distortion (JND) coding whereas the amount of coding distortion introduced in each image area is just noticeable by any human observer.

The ID profile can be used to increase the amount of information discarded during compression. In one example the higher discarded amount is obtained by scaling residual values r with a scaling parameter Δ. The scaling parameter will depend on the average pixel intensity μ and the ID profile.

It is important to note that the aforementioned Δ scaling parameter is also needed at the decoder side in order to properly perform re-scaling. However, the value for Δ depends on the ID (μ) which in turn depends on the average intensity value μ for the image block being decoded. Usually, μ is computed over the original video data which are now needed also at the decoder side for inverse quantisation. To avoid the transmission of the original data to the decoder, the μ value can be computed from the predictor or the already reconstructed pixels.

The representative image intensity may be an average luminance value.

A selected ID profile operating on the average luminance value for a block may be used in the scaling of luminance and chrominance values. Another approach is to select different IDQ profiles for each component (e.g. Y, U and V, or R, G and B, depending on the chosen colour space format).

Preferably, a graphical representation of the ID profile is parameterised and the ID profile is signalled through a small number of ID profile parameters. The number of parameters may be very much smaller then the number of intensity points (e.g. 2⁸) which can enable very efficient compression of the ID profile by transmitting only a few numbers.

It should be understood that whilst the present invention offers important advantages where the scaling is in accordance with intensity, it is not so limited. Therefore the described ID profile is only an example of a compression control rule and image intensity is only an example of a compression control parameter. In a variation, the compression control parameter may comprise motion information with the compression control rule styled accordingly.

Thus, more generally, a coding system may involve a non-linear signal expansion where the dynamic range is compressed during quantisation/transform and is expanded to the original range at the point of reconstruction at the decoder. Non-linear expansion is driven by reconstruction signals represented by the compression control rule and compression control parameters such as prediction intensity, motion information, spatial pixel activity, residuals energy, etc.

The present invention consists in a further aspect in a method of decoding a compressed bitstream in which bitstream values are inverse quantised and where appropriate inverse transformed to form an image block; characterised by the steps of receiving in association with the bitstream a signalled compression control rule; and varying values of the image block in accordance with the signalled compression control rule operating on an identified compression control parameter.

The step of varying values may comprise expanding the dynamic range. The values that are varied may be residual values formed prior to addition of a prediction. The compression control parameter may be a representative image intensity for a transform block or other image area.

In one example, a prediction is received for a block, and the representative image intensity is formed for a block by computing the average image intensity of the prediction for that block or by the blocks in the neighbourhood.

It will be understood that embodiments of this invention allow a different compression control rule to be used for each spatio-temporal video segment to allow broadcaster and video content producers to encode a given segment by preserving more some image details or by smoothing some others. Moreover, the usage of said control rule may allow the creation of some effects in the coded video as for example, fading shot transition, weighted prediction, colour contrast enhancement, etc.

### BRIEF DESCRIPTION OF THE DRAWINGS

FIG. 1 shows an example of a known Just Noticeable Difference (JND) profile curve which, as stated above, can be considered as a special case of ID profile.

FIG. 2 shows an example of the Δ and idP profiles, highlighting their correspondences.

FIGS. 3 and 4 show examples of a schematic encoder block diagram when the scaling is used.

FIG. 5 shows an example of schematic decoder block diagram when the scaling is used.

FIG. 6 shows an example of schematic decoder block diagram when the precision is increased in the inverse transform module.

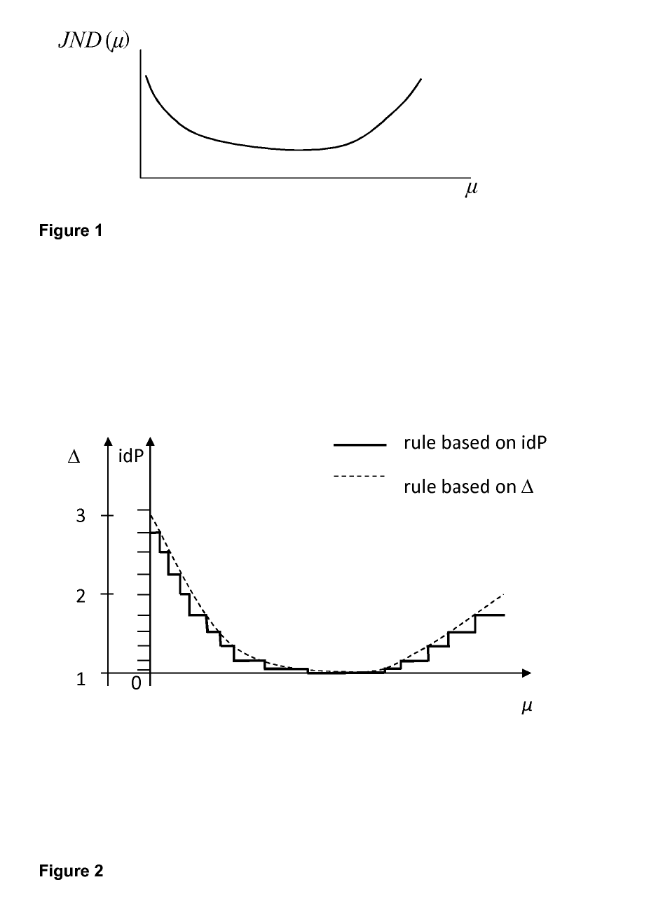

### DETAILED DESCRIPTION OF THE PRESENT INVENTION

The present invention will now be described by a way of examples.

In one example of an encoding process according to the invention, the prediction residue to be frequency transformed and subsequently quantised, is scaled in order to reduce its magnitude. To this end, the residue prior transformation can be scaled by the following operation:

$${r}^{′} = ⌊ \frac{r}{Δ} ⌋$$

where r denotes the prediction residue, r′ denotes the scaled residue and Δ is a scaling parameter.

In the inverse scaling process, the residue reconstructed after inverse transformation is re-scaled by applying a re-scaling operation described by the following operation:

\hat{r}=\hat{r}′×Δ

where \hat{r} denotes the final reconstructed residue and \hat{r}′ denotes the reconstructed residue after inverse transformation.

In one form of the invention, the scaling parameter Δ varies with image intensity according an ID profile. The well known Just Noticeable Distortion (JND) profile as an example of an ID profile.

ID profile derivation and transmission

From several experimental records available in the literature, it is known that the average pixel intensity masking profile (i.e. the ID profile) related to the human visual system is a U-shape curve, ID=ID (μ) where μ denotes the average intensity value for the block being coded. Since the ID profile is needed at the decoder side to perform inverse scaling, a compact way to represent this profile is proposed in this invention.

ID profile derivation and transmission

In addition to the sending of Δ for intensity values, here an alternative way is also described. An ID profile may be used to vary the scaling parameter Δ, indirectly. A parallel may be drawn with quantisation, where a quantisation parameter QP is varied, rather than directly varying the quantisation step Δ. Here QP is different than the one used in conventional quantisation that is performed in transform domain.

Generally, θ is invertible, that is QP=θ⁻¹(Δ). Furthermore, QP takes integer values which yields to: QP=floor(θ⁻¹(Δ)+0.5). Here such quantisation parameter is called Intensity differential quantisation parameter P (idP). The strength of its quantisation can be related to the strength of the quantiser in the conventional quantisation, for implementation purposes. As an example, the quantiser used in both the H.264/AVC and the HEVC standards, uses a nonlinear mapping/relationship θ given as follows:

$$Δ = {2}^{\frac{QP - 4}{6}} , \qquad ( 1 )$$

That is, the quantisation step Δ doubles in size for each QP increment of six and Δ(QP=0)=0.625. Using this example in the scaling case of the present embodiment leads to the idP curve profile depicted in FIG. 2 whereas also the related ID (Δ) profile is shown.

In one arrangement, an ID profile may be signalled to the decoder. The decoder can then derive the appropriate idP profile.

In an alternative, the idP profile may be derived at the coder and signalled to the decoder. For example, a number of points in which idP changes (other than the point μ=0) are sent to the decoder. Therefore, for μ=0, only idP(0) is sent, then for the other points such that idP(μ−1)≠idP(μ), pairs (μ, idP(μ)) are sent. Alternatively, a difference of these parameters, between points n-1 and n can be sent: (μₙ−μₙ₋₁, idP(μₙ)−idP(μₙ₋₁)).

It will frequently be the case that even where idP changes it will change by only ±1.The number of bits needed fo profile transmission can then be reduced further. So If ∀ μ>0, |idP(μ−1)−idP(μ)|∈{0 ,1}, then the profile can be communicated in the same way as above, with a difference that the pairs include (μ, b(μ)), where b(μ) is a single value which defines whether idQP values increases or decreases in μ, with respect to idP(μ−1).

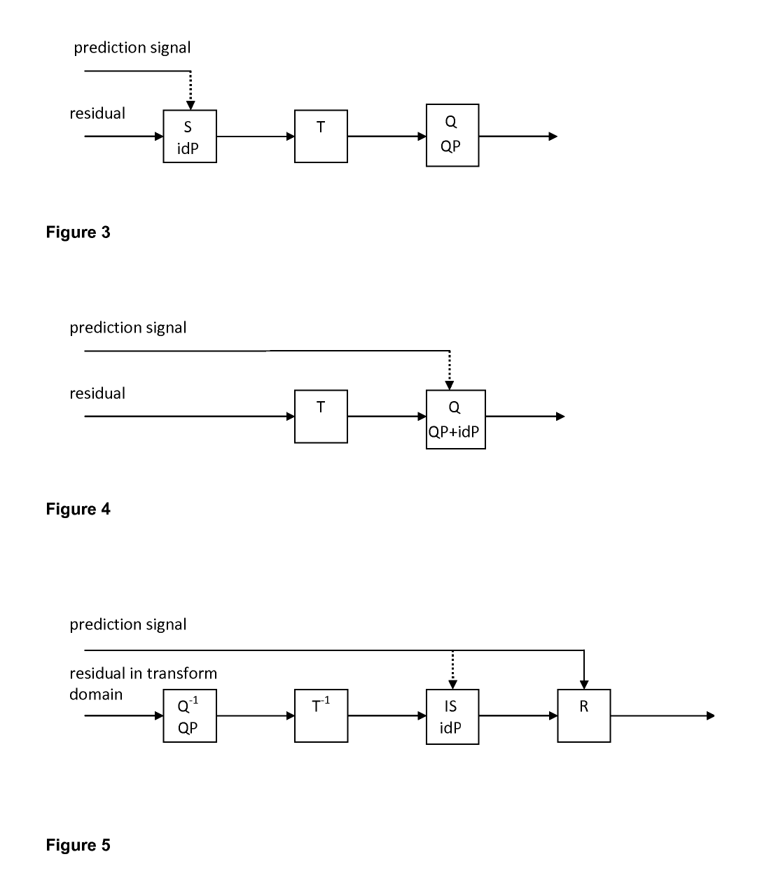

Examples of encoders utilising the present invention are shown in FIGS. 3 and 4.

FIG. 3 shows a scaler process S which receives the residual from an appropriate prediction process. The scaled residual then passes through a transform process T and a quantiser process Q. It will be understood that the transform process T operates on transform blocks and that the transform may be skipped for certain blocks. Where a transform is skipped, the transform process T may apply a scaling factor to bring untransformed image values to the same level as transformed coefficients, as shown for example in WO 2013/001279.

In the FIG. 3 arrangement, the transform process T and the quantiser process Q may be conventional.

In the scaling process S, rule parameters are used with a representative image intensity to determine the strength of scaling (idP). Not shown, the rule is also provided to the entropy encoding block for incorporation in the output bitstream. For inter and/or intra coded blocks, a representative image intensity is estimated for the block by calculating an average luminance from either the block prediction (as indicated in the FIG. 3) or the neighbouring blocks already reconstructed in the local decoder loop. In a modification, use of already reconstructed neighbouring blocks may be made for all images, in place of using the prediction.

In FIG. 3, first the residual is scaled, then it is transformed (T) and quantised (Q). It is however possible to perform this scaling jointly with quantisation, as demonstrated in

FIG. 4. In this arrangement, the transform process T remains conventional but the quantiser process Q is modified. In FIG. 4, the rule parameters are provided not to the scaling process S but to the quantiser process Q and are there used with a representative image intensity (which may as in FIG. 3 be an average luminance from the block prediction) to determine the strength of scaling in the form of a parameter idP which can be summed with the quantisation parameter QP which would otherwise have been employed.

An example of a decoder utilising the present invention is shown in FIG. 5. Again, much of the decoder is of standard form (utilising dequantisation Q⁻¹ and inverse transform T⁻¹) and will not be described here.

The rules for scaling are extracted in the entropy decoding process and provided to an inverse scaling process IS. This computation block has available to it the prediction for the current block or selected already decoded blocks, for estimation of the representative image intensity as described above. The idP level is decided in that block for inverse scaling. The inverse scaling process then applies the final scaling of pixels to be used to reconstruct the decoded coefficients.

It will be observed in this case, the Q⁻¹ stage is conventional and in particular does not rely upon the average pixel intensity μ and for this reason does not require access to the prediction. In some decoder architectures, this may allow efficiencies or time savings.

Where appropriate, the scaling process may be enabled or disabled as signalled by—for example—image segment or image block related coding flags.

Computation of Average Pixel Intensity

It is also optionally specified how to compute the average pixel intensity μ, independently from the internal bit depth used by the encoder and decoder to represent image pixels. In fact, some video coding standards allow the encoder and decoder to change the internal bit depth representation for source pixels to compensate for rounding errors happening at various processing stages (e.g. motion compensation, transform, etc.). In some embodiments of the present invention the average operation to obtain average pixel intensity for an image block is specified in such a way that the output is always kept into n bits. Therefore, assuming that both the encoder and decoder use m with m>n bits to internally represent image pixels, for an image block with R rows and C columns, the average pixel intensity is μ given by:

$$μ = ( {\sum }_{x = 0}^{R - 1} {\sum }_{y = 0}^{C - 1} ( P ( x , y ) + o ) ≫ ( m - n ) + q ) ≫ {log}_{2} ( R \times C ) , \qquad ( 5 )$$

where>>denotes the right bit shift operation and o, q are rounding offsets. The values for these offsets are o=2^{(m-n-1)} and q=2^{log}^{₂}^{(R×C)-1}. Usually, in video coding standards, it is assumed that the product R×C is always a power of 2 for optimisation purposes. In this case the operation log₂(R×C) always produces integer number results.

It will be understood that the techniques described and claimed here will typically form only a relatively small part of a complete encoding or decoding system. Also those techniques may be employed for some but not all images or image regions in a video sequence.

Dynamic Range Variation at the Reconstruction

In conventional video compression systems, inverse transform is the last step before reconstruction. Therefore, the inverse transform has typically incorporated mechanisms that bring the underlying signal to the required level. This process often results in some reduction of precision. While that amount of the loss is not in the general case significant, in the case when inverse scaling is used after inverse transform, it may be beneficial to preserve as much of the signal's precision before the final scaling.

Therefore the final scaling may incorporate this fact into account. In that case, when scaling is used, some changes to the inverse transform are needed. For illustration, a case is considered where higher precision is preserved by modifying bit-shifting amount the inverse transform performs.

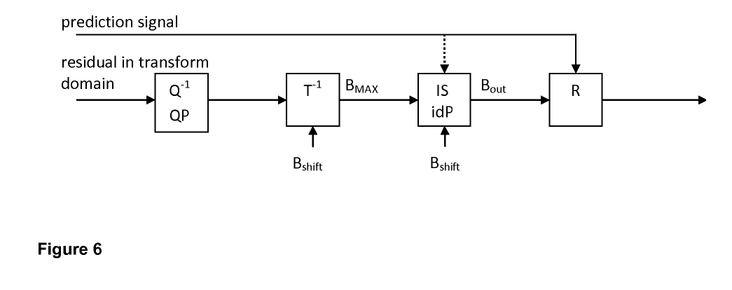

According to FIG. 5, the scaling at the decoder proposed in this invention is performed after inverse transformation. The output of the inverse transformation module, i.e. the reconstructed prediction residuals, is represented with a fewer number of bits than the reconstructed coefficients. This smaller number of bits leads to a lower precision in the residuals representation which may not be well suited also in the inverse scaling module. To preserve the same representation of the reconstructed coefficients, an alternative way of performing inverse transformation and scaling is described and illustrated in FIG. 6. Let Bₒᵤₜ be the number of bits that are needed for the inverse transform output. In HEVC, that is Bₒᵤₜ=9+BDI, where BDI is the internal bit depth increase (i.e. 0 for 8 bit output, or 2 for 10 bit output). However, at that point one can allow maximal precision B_{MAX}, which is 16 bits in HEVC. The rationale behind the representation increment is the higher the precision, the more precise the signal to be scaled is. This can be controlled by changing the transform, so that its output is shifted less then without scaling. The difference in transform's shifting is:

B_{shift}=B_{MAX}−Bₒᵤₜ.

It is important to take into account such precision adjustment during scaling, so that the output of the scaling is at Bₒᵤₜ. To achieve that for this example case, the final reconstructed residuals are obtained as follows:

\hat{r}=(\hat{r}×Δ)>>B_{shift}.

As will be seen in the FIG. 6 arrangement the value B_{shift} is provide both to the inverse transform process T⁻¹ and to the inverse scaling process IS.

It will be understood that this invention has been described by way of examples only and that a wide variety of modifications are possible without departing from the scope of the invention. Thus the described ID profile is only one example of a compression control rule that can be selected and signalled in association with the compressed bitstream for use at the decoder. Similarly, representative image intensity is only one example of a compression control parameter that can be identified for an image area, the compression control parameter varying between at least some image areas.

1. A method of video coding in a video encoder in which an image having image intensity values is divided into blocks; image intensity values in at least some blocks are transformed to provide transform coefficients and said transform coefficients or untransformed image intensity values are quantised with quantisation parameters to derive a compressed bitstream; comprising the steps of:
selecting a compression control rule;
for an image area, identifying a compression control parameter, the said compression control parameter varying between at least some image areas;
varying image intensity values in the image area in accordance with said compression control rule operating on said compression control parameter; and
signalling the selected compression control rule in association with the compressed bitstream for use at the decoder.

2. A method of decoding a compressed bitstream in a bitstream decoder in which bitstream values are inverse quantised and, where appropriate, inverse transformed to form an image block; characterised by the steps of:
receiving in association with the bitstream a signalled compression control rule; and
varying values of the image block in accordance with the signalled compression control profile operating on an identified compression control parameter,
wherein the values that are varied are image data values at the decoder before final reconstruction.

3. A method according to claim 1, in which the step of varying values comprises or compressing the dynamic range.

4. A method according to claim 2 in which the step of varying values comprises expanding the dynamic range of values at the decoder.

5. (canceled)

6. (canceled)

7. A method according to claim 2, wherein the compression control parameter comprises a representative image intensity for the image area.

8. A method according to claim 2 whereby the usage of the compression control rule is enabled or disabled by image segment or image block related coding flags.

9. (canceled)

10. A method according to claim 2 in which the compression control profile is signalled through data pairs, each representing an image intensity change data value and related scaling step change data value.

11. A method according to claim 3, wherein the compressing of the dynamic range comprises scaling by a scaling parameter and in which the scaling is defined by related quantisation parameter which is also varied in accordance with the compression control rule.

12. A method according to claim 11 in which a quantisation parameter value change has two possible values corresponding respectively with an increase and a decrease in related quantisation parameter by 1.

13. A method according to claim 2 in which a compression control rule is selected for each spatio-temporal video segment, which spatio-temporal video segment is selected from the group consisting of an image region, a slice; a plurality of images, a Group Of Pictures (GOP); a video shot or a video programme.

14. A method according to claim 7, in which the representative image intensity is an average luminance value.

15. A method according to claim 7, in which a prediction is formed for a block, wherein representative image intensity is estimated for a block by computing the average image intensity of the prediction for that block.

16. A method according to claim 7, in which representative image intensity is estimated for a block by computing the average image intensity of selected reconstructed neighbouring blocks.

17. A method according to claim 2 whereby the output bit precision of the inverse transformation process at the decoder is maximised to preserve highest precision of the signal to be scaled.

18. A method according to claim 17 whereby the inverse scaling compensates for maximising the precision during the inverse transform, to bring the signal to its required output precision.

19. A method according to claim 17 whereby the precision representation used in the inverse scaling process is increased.

20. (canceled)

21. (canceled)

22. A non-transitory computer program product containing instructions for implementation of a method of decoding a compressed bitstream in which bitstream values are inverse quantised and, where appropriate, inverse transformed to form an image block; characterised by the steps of receiving in association with the bitstream a signalled compression control rule; and varying values of the image block in accordance with the signalled compression control profile operating on an identified compression control parameter, wherein the values that are varied are image data values at the decoder before final reconstruction.

23. A method according to claim 1, wherein the compression control parameter comprises a representative image intensity for the image area.

24. A method according to claim 4, wherein the expanding of the dynamic range comprises scaling by a scaling parameter and in which the scaling is defined by related quantisation parameter which is also varied in accordance with the compression control rule.

25. A method according to claim 24 in which a quantisation parameter value change has two possible values corresponding respectively with an increase and a decrease in related quantisation parameter by 1.
